(19) United States
(12) Patent Application Publication
(10) Pub. No.: US 2026/0121178 A1
(43) Pub. Date: Apr. 30, 2026

(54) BATTERY CELL AND BATTERY MODULE INCLUDING THE SAME

(71) Applicant: SK ON CO., LTD., Seoul (KR)

(72) Inventor: Seung Min LEE, Daejeon (KR)

(21) Appl. No.: 19/329,586

(22) Filed: Sep. 16, 2025

(30) Foreign Application Priority Data
Oct. 30, 2024 (KR) 10-2024-0150808

(51) Int. Cl. H01M 50/14; H01M 10/04; H01M 50/103; H01M 50/117; H01M 50/131; H01M 50/242; H01M 50/54

(52) U.S. Cl. CPC H01M 50/14; H01M 10/0486; H01M 50/103; H01M 50/117; H01M 50/131; H01M 50/242; H01M 50/54

(57) ABSTRACT

The present disclosure includes a battery cell including an electrode assembly including a positive electrode plate, a negative electrode plate, and a separator; an electrode lead electrically connected to the electrode assembly; a support member covering at least a portion of the electrode assembly; an elastic member providing elastic force to the support member; and a cell casing accommodating the electrode assembly, the support member, and the elastic member therein, wherein the support member includes a first support member covering one surface of the electrode assembly, and a second support member covering the other surface of the electrode assembly, and the elastic member provides elastic force to the first support member and the second support member.

### CROSS-REFERENCE TO RELATED APPLICATION(S)

This patent document claims the priority and benefits of Korean Patent Application No. 10-2024-0150808 filed on Oct. 30, 2024, the disclosure of which is incorporated herein by reference in its entirety.

### TECHNICAL FIELD

The disclosure and implementations disclosed in this patent document generally relate to a battery cell (secondary battery) including a support member, and a battery module including the same.

### BACKGROUND

Unlike a primary battery, a secondary battery may charge and discharge electricity, and may be used as power sources in devices within various fields such as a digital camera, a mobile device, an electric vehicle, an energy storage system (ESS), and the like. The secondary battery may be provided as various types of secondary batteries, such as a lithium secondary battery, a nickel-cadmium battery, a nickel-metal hydride battery, and the like, and may be manufactured as a flexible pouch-type battery cell or a rigid can-type battery cell. The can-type battery cells may be divided into a prismatic battery cell, a cylindrical battery cell, a coin-type battery cell, and the like, according to an exterior thereof, and each type may be variously applied, depending on a device and an environment to be used.

A plurality of battery cells may be formed as a stacked cell assembly. The cell assembly may be disposed in a module housing to form a battery module, and a plurality of battery modules may be disposed in a pack frame to form a battery pack.

### SUMMARY

A battery cell may include an electrode assembly and a cell casing accommodating the electrode assembly.

When a physical impact occurs in a battery cell, there may be a risk that a short circuit may occur due to contact between electrodes in an electrode assembly.

In a battery cell, a swelling phenomenon may occur in which an electrode assembly expands and internal pressure of the battery cell increases during a process of charging and discharging electricity by the battery cell. In addition, due to expansion and contraction of the electrode assembly, performance of the battery cell may deteriorate.

According to an aspect of the present disclosure, a battery cell capable of suppressing a swelling phenomenon of the battery cell, and a battery module including the same may be provided.

According to an aspect of the present disclosure, a battery cell capable of protecting an electrode assembly from external physical impacts, and a battery module including the same may be provided.

According to an aspect of the present disclosure, a battery cell with increased rigidity and durability, and a battery module including the same may be provided.

According to an aspect of the present disclosure, a battery cell capable of providing a uniform surface pressure to an electrode assembly to suppress expansion of the electrode assembly, and a battery module including the same may be provided.

A battery cell and a battery module including the same of the present disclosure may be widely applied to devices within green technology fields such as an electric vehicle, a battery charging station, a photovoltaic power generator using other batteries, a wind power generator, and the like. In addition, a battery cell and a battery module including the same of the present disclosure may be used in an eco-friendly electric vehicle, a hybrid vehicle, or the like to prevent climate change by suppressing air pollution and greenhouse gas emissions.

In some embodiments of the present disclosure, a battery cell according to the present disclosure includes a battery cell including an electrode assembly including a positive electrode plate, a negative electrode plate, and a separator; an electrode lead electrically connected to the electrode assembly; a support member covering at least a portion of the electrode assembly; an elastic member providing elastic force to the support member; and a cell casing accommodating the electrode assembly, the support member, and the elastic member therein, wherein the support member includes a first support member covering one surface of the electrode assembly, and a second support member covering the other surface of the electrode assembly, and the elastic member provides elastic force to the first support member and the second support member.

According to an embodiment, the first support member may cover a top surface of the electrode assembly, the second support member may cover a bottom surface of the electrode assembly, and an area of the top surface and an area of the bottom surface of the electrode assembly may be greater than an area of one of other surfaces of the electrode assembly, respectively.

According to an embodiment, at least one of the first support member or the second support member may include a plurality of through-holes.

According to an embodiment, the plurality of through-holes may have a lattice shape or a honeycomb shape.

According to an embodiment, the elastic member may be coupled to at least one of the first support member or the second support member.

According to an embodiment, the elastic member may include a first elastic member disposed on a corner portion of the support member.

According to an embodiment, the elastic member may further include a second elastic member disposed in a region excluding the corner portion, in edges of the support member.

According to an embodiment, the battery cell may further include a holder member coupled on an external side of the first support member and an external side of the second support member to suppress deformation of the elastic member.

According to an embodiment, an inner height of the holder member may be 110% to 140% of a thickness of the electrode assembly before expansion of the electrode assembly.

According to an embodiment, the holder member may be coupled on the external side of the first support member and the external side of the second support member, and may include a first holder member disposed on a corner portion of the support member.

According to an embodiment, the holder member may be coupled to the external side of the first support member and the external side of the second support member, and may further include a second holder member disposed on a side surface of the support member.

According to an embodiment, the support member may include a material having a heat resistance of 100° C. or higher and an insulation of 10⁶ Ωm (ohm meter) or higher.

According to an embodiment, the support member may include a material in which a ceramic-based filler is included in a polymer matrix.

A battery cell according to the present disclosure includes an electrode assembly including a positive electrode plate, a negative electrode plate, and a separator; an electrode lead electrically connected to the electrode assembly; a support member covering an entire surface of the electrode assembly; and a cell casing accommodating the electrode assembly and the support member therein, wherein the support member includes a third support member covering a surface on which the electrode lead is located, and a fourth support member covering a surface on which the electrode lead is not located, and the third support member includes an opening formed to protrude the electrode lead externally.

According to an embodiment, at least one of the third support member or the fourth support member may include a plurality of through-holes.

A battery module according to the present disclosure includes a plurality of battery cells; and a module housing including the plurality of battery cells, wherein the support member includes an electrode assembly including a positive electrode plate, a negative electrode plate, and a separator; an electrode lead electrically connected to the electrode assembly; a support member covering at least a portion of the electrode assembly; an elastic member providing elastic force to the support member; and a cell casing accommodating the electrode assembly, the support member, and the elastic member therein, wherein the support member includes a first support member covering one surface of the electrode assembly, and a second support member covering the other surface of the electrode assembly, and the elastic member provides elastic force to the first support member and the second support member.

### BRIEF DESCRIPTION OF DRAWINGS

Certain aspects, features, and advantages of the present disclosure may be illustrated by the following detailed description with reference to the accompanying drawings.

FIG. 1 is a perspective view schematically illustrating a battery cell according to a first embodiment.

FIG. 2 is an exploded perspective view of the battery cell illustrated in FIG. 1, from which the cell casing is excluded.

FIG. 3 is a perspective view illustrating an internal portion of the cell casing of the battery cell illustrated in FIG. 1.

FIG. 4 is a perspective view illustrating a deformed state in the cell casing illustrated in FIG. 3.

FIG. 5A is a cross-sectional view of FIG. 3, taken along line I-I′, and FIG. 5B is a cross-sectional view of FIG. 4, taken along line II-II′.

FIGS. 6A to 6C are plan views illustrating various modified examples of a state in which a cell casing and a first support member of a battery cell according to a first embodiment are excluded.

FIG. 7 is a perspective view illustrating an internal portion of a cell casing of a battery cell according to a second embodiment.

FIG. 8 is a perspective view illustrating an internal portion of a cell casing of a battery cell according to a third embodiment.

FIG. 9 is a perspective view illustrating a deformed state in the internal portion of the cell casing illustrated in FIG. 8.

FIG. 10A is a cross-sectional view of FIG. 8, taken along line III-III′, and FIG. 10B is a cross-sectional view of FIG. 9, taken along line IV-IV′.

FIG. 11 is a perspective view illustrating an internal portion of a cell casing of a battery cell according to a fourth embodiment.

FIG. 12 is a perspective view illustrating an internal portion of a cell casing of a battery cell according to a fifth embodiment.

FIG. 13 is an exploded perspective view of a battery cell according to a fifth embodiment, from which a cell casing is excluded.

FIG. 14 is an exploded perspective view of a battery module.

### DETAILED DESCRIPTION

Features of the present disclosure disclosed in this patent document may be described by example embodiments with reference to the accompanying drawings.

Hereinafter, the present disclosure will be described in detail with reference to the accompanying drawings. However, the present disclosure is only illustrative, and the present disclosure is not limited to the specific embodiments illustrated.

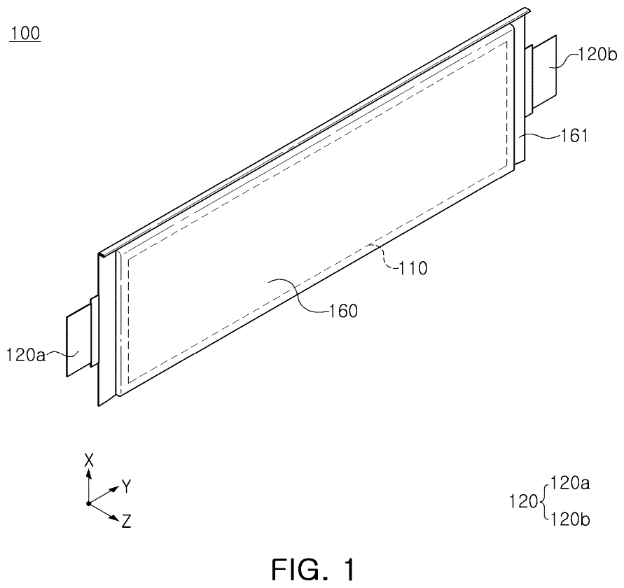

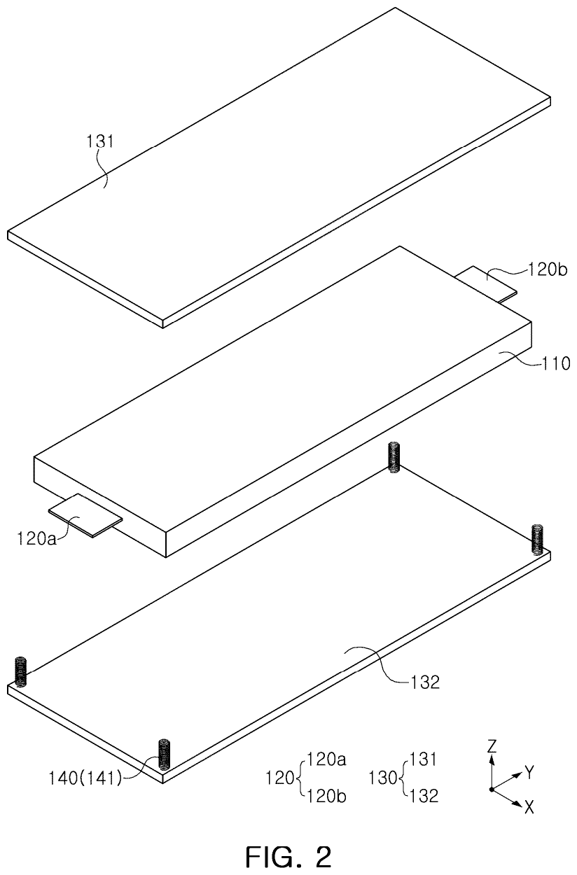

First, a battery cell 100 according to a first embodiment of the present disclosure will be described with reference to FIGS. 1 and 2.

FIG. 1 is a perspective view schematically illustrating a battery cell 100 according to a first embodiment, and FIG. 2 is an exploded perspective view of the battery cell 100 according to the first embodiment, from which the cell casing 160 is excluded.

Referring to FIGS. 1 and 2, a battery cell 100 according to a first embodiment of the present disclosure may include a cell casing 160, an electrode assembly 110, an electrode lead 120, a support member 130, and an elastic member 140.

The battery cell 100 of the present disclosure may be formed as a secondary battery capable of charging and discharging electricity. The battery cell 100 may have a configuration in which the electrode assembly 110 and an electrolyte are accommodated in the cell casing 160. As an example, the battery cell 100 may be formed as a lithium ion (Li-ion) battery or a nickel metal hydrogen (Ni-MH) battery, but a type thereof is not limited thereto.

The battery cell 100 according to the first embodiment may include the electrode assembly 110 including a positive electrode plate, a negative electrode plate, and a separator, the electrode lead 120 electrically connected to the electrode assembly 110, the support member 130 covering at least a portion of the electrode assembly 110, the elastic member 140 providing elastic force, and the cell casing 160 accommodating the electrode assembly 110, the support member 130, and the elastic member 140 therein.

The battery cell 100 may have a configuration in which the electrode assembly 110, the electrolyte, the support member 130, and the elastic member 140 are accommodated in the cell casing 160 forming an exterior material.

Although the battery cell 100 illustrates a pouch-type cell in the present disclosure, the battery cell 100 may be applied to a different type of battery cell 100 such as a prismatic cell and the like.

The electrode assembly 110 may include the positive electrode plate, the negative electrode plate, and the separator. The separator may prevent contact between the positive electrode plate and the negative electrode plate. The electrode assembly 110 may have various types such as a winding type, a stacking type, a zigzag-folding type, a stack-folding type, and the like.

The electrode lead 120 may be electrically connected to the electrode assembly 110. Electrode leads 120 may be disposed on both sides of the battery cell 100 in a longitudinal direction Y, to face opposite directions. For example, the electrode lead may include a positive electrode lead 120a of a first polarity (e.g., a positive electrode) toward one side of the battery cell 100 in the longitudinal direction, and a negative electrode lead 120b of a second polarity (e.g., a negative electrode) toward the other side in the longitudinal direction. A direction in which the electrode lead 120 is located may be variously changed according to specifications of the battery cell 100.

The support member 130 may cover at least a portion of the electrode assembly 110. The support member 130 may protect the electrode assembly 110 from external impacts.

The support member 130 may serve to suppress deformation of the electrode assembly 110 generated during a process of charging or discharging electricity.

In the first embodiment, the support member 130 may include a first support member 131 covering one surface (a first surface) of the electrode assembly 110, and a second support member 132 covering the other surface (a second surface) of the electrode assembly 110.

The first support member 131 and the second support member 132 may cover one surface of the electrode assembly 110 on which the electrode lead 120 is not located, and the other surface of the electrode assembly 110 on which the electrode lead 120 is not located.

The first support member 131 and the second support member 132 may be disposed, with the electrode assembly 110 interposed therebetween, to suppress expansion of the electrode assembly 110 due to a swelling phenomenon. For example, the first support member 131 and the second support member 132 may be disposed on opposite sides in a thickness direction (Z-axis) of the electrode assembly 110, with the electrode assembly 110 interposed therebetween.

Due to the expansion of the electrode assembly 110, the first support member 131 and the second support member 132 may move in a direction (Z-axis direction) away from each other.

The first support member 131 and the second support member 132 may have the same shape as one surface of the electrode assembly 110, corresponding thereto, to effectively suppress the expansion of the electrode assembly 110. A width (width of an X-Y plane) of the first support member 131 and the second support member 132 may be greater than a width of one surface of the electrode assembly 110 corresponding thereto.

The first support member 131 and the second support member 132 may have the same size and shape, but are not limited thereto.

Heat may be generated in the electrode assembly 110 during a process of charging or discharging electricity. The support member 130 may include a material having heat resistance to withstand heat generation of the electrode assembly 110 and to be minimally deformed.

The support member 130 may include a material having insulation to maintain electrical insulation between the electrode assembly 110 and the cell casing 160.

For example, the support member 130 may include a material having a heat resistance of 100° C. or higher and an insulation of 10⁶ Ωm (ohm meter) or higher.

The support member 130 may include a material having strength to protect the electrode assembly 110 from external impact. The support member 130 may include a material having rigidity to be minimally deformed when a swelling phenomenon occurs. For example, the support member 130 may include a material having rigidity to resist deformation when pressure is transmitted due to expansion of the electrode assembly 110.

For example, the support member 130 may include a material in which a ceramic-based filler is included in a polymer matrix.

The ceramic-based filler may be boron nitride (BN), aluminum nitride (AlN), or aluminum oxide (Al₂O₃), but is not limited thereto. When the support member 130 includes the material in which the ceramic-based filler is included in the polymer matrix, heat resistance, insulation, strength, or the like of the support member 130 may be improved.

The support member 130 may include a material having strength, rigidity, heat resistance, insulation, or the like. For example, the support member 130 may include a material such as aluminum oxide (Al₂O₃), silicon carbide (SiC), silicon oxide (SiO₂), or the like, but is not limited thereto.

The elastic member 140 may provide elastic force to the first support member 131 and the second support member 132.

The elastic member 140 may be disposed between the first support member 131 and the second support member 132 to provide elastic force to the first support member 131 and the second support member 132.

When the electrode assembly 110 expands due to a swelling phenomenon to increase a distance between the support members 130, the elastic member 140 may extend. The elastic member 140 may apply elastic force to the support member 130. The support member 130 may provide a surface pressure to the electrode assembly 110.

The elastic member 140 may apply elastic force to the support member 130 in the thickness direction (Z-axis) of the electrode assembly 110, when the electrode assembly 110 expands. The support member 130 may provide a surface pressure to the electrode assembly 110 in the thickness direction (Z-axis) of the electrode assembly 110. The elastic member 140 may be disposed to provide elastic force in the thickness direction (Z axis) of the electrode assembly 110.

The elastic member 140 may be coupled to at least one of the first support member 131 or the second support member 132. For example, the elastic member 140 may be coupled to the first support member 131 and the second support member 132, respectively.

Coupling between the elastic member 140 and the first support member 131 or coupling between the elastic member 140 and the second support member 132 may be performed by welding or an adhesive. In addition, various techniques such as magnet coupling, forcedly fitting coupling, and the like may be applied, and the present disclosure is not limited to the coupling methods.

The elastic member 140 may include a spring. When the elastic member 140 is the spring, an appropriate spring constant may be changed depending on a degree of expansion of the electrode assembly 110 due to a swelling phenomenon. A range of the spring constant may be greater than or equal to 100 kgf/mm, and less than or equal to 800 kgf/mm, but is not limited thereto.

The cell casing 160 may form at least a portion of an exterior of the battery cell 100. The cell casing 160 may accommodate the electrode assembly 110, the support member 130, and the elastic member 140 therein.

The cell casing 160 may include an electrode accommodating portion accommodating the electrode assembly 110, and a sealing portion 161 sealing at least a portion of a periphery of the electrode accommodating portion. The electrode accommodating portion may provide a space in which the electrode assembly 110 and the electrolyte are accommodated.

The sealing portion 161 may be formed by bonding at least a portion of a periphery of the cell casing 160. The sealing portion 161 may be formed in a flange shape extending outward from the electrode accommodation portion formed in a container shape, and may be disposed along at least a portion of an external of periphery the electrode accommodation portion.

When the battery cell 100 is a pouch-type cell, the cell casing 160 may include a pouch film. When the battery cell 100 is a prismatic cell, the cell casing 160 may have a can shape.

The electrode assembly 110 may be mounted in a state in which the support member 130 and the elastic member 140 are coupled to each other. To insert the electrode assembly 110, the elastic member 140 may be extended by applying force in a direction in which a distance between the first support member 131 and the second support member 132 increases. The electrode assembly 110 may be located between the first support member 131 and the second support member 132. The electrode assembly 110 may be stably fixed by removing a force applied after the electrode assembly 110 is inserted, to restore the elastic member 140 to an original length thereof.

In the first embodiment, the first support member 131 may cover an upper surface (top surface) of the electrode assembly 110, the second support member 132 may cover a lower surface (bottom surface) of the electrode assembly 110, and the upper and lower surfaces of the electrode assembly 110 may be greater than one of other surfaces of the electrode assembly 110, respectively.

When the support member 130 covers the upper and lower surfaces of the electrode assembly 110 greater than one of other surfaces of the electrode assembly 110, the electrode assembly 110 may be more effectively protected. When the support member 130 covers the upper and lower surfaces of the electrode assembly 110 greater than one of other surfaces of the electrode assembly 110, the support member 130 may more effectively provide a uniform surface pressure to the electrode assembly 110.

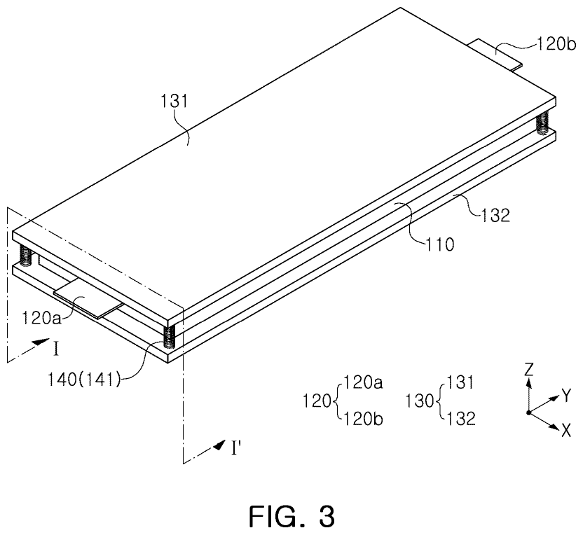

Referring to FIGS. 3, 4, 5A, and 5B, the battery cell 100 according to the first embodiment of the present disclosure will be described.

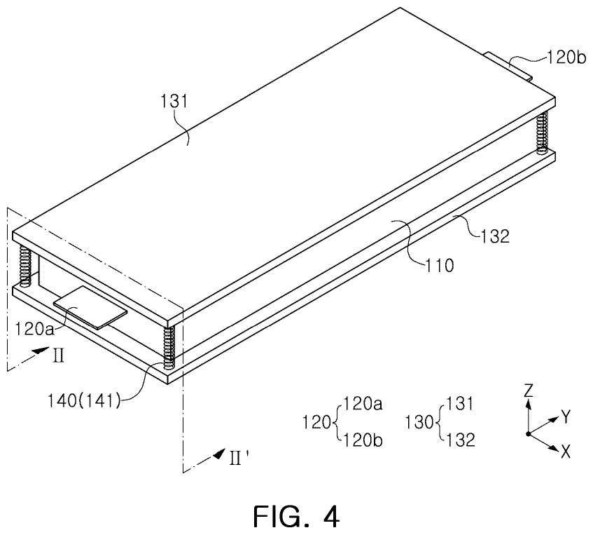

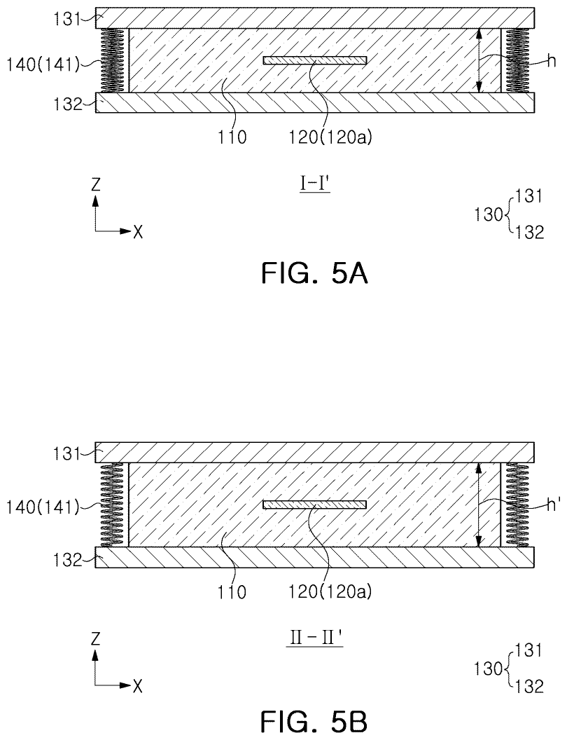

FIG. 3 is a perspective view illustrating an internal portion of the cell casing 160 of the battery cell 100 illustrated in FIG. 1, and FIG. 4 is a perspective view illustrating a deformed state in the cell casing 160 illustrated in FIG. 3. FIG. 5A is a cross-sectional view of FIG. 3, taken along line I-I′, and FIG. 5B is a cross-sectional view of FIG. 4, taken along line II-II′.

Referring to FIGS. 5A and 5B, in the battery cell 100, a swelling phenomenon in which the electrode assembly 110 expands due to an increase in internal pressure of a battery during a process of charging and discharging electricity of the battery may occur.

When the swelling phenomenon occurs, the electrode assembly 110 may expand in the thickness direction (Z axis) of the electrode assembly 110. For example, a thickness of the electrode assembly 110 before expansion thereof may be h. A thickness of the electrode assembly 110 after the swelling phenomenon occurs and expansion thereof may be h′. h′ may be a value exceeding h.

Due to the expansion of the electrode assembly 110, the first support member 131 and the second support member 132 may move in a direction (Z-axis direction) away from each other.

When the electrode assembly 110 expands to increase a distance between the first support member 131 and the second support member 132, the elastic member 140 may extend. The elastic member 140 may apply elastic force to the support member 130 to suppress the swelling phenomenon. The support member 130 may provide a surface pressure to the electrode assembly 110 to suppress the expansion of the electrode assembly 110.

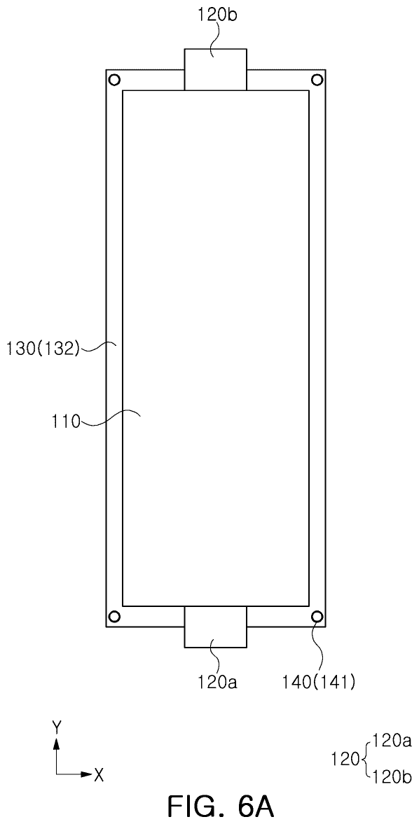

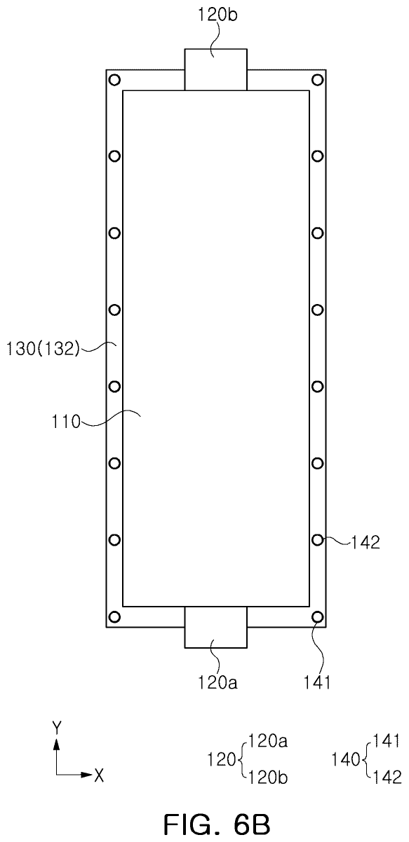

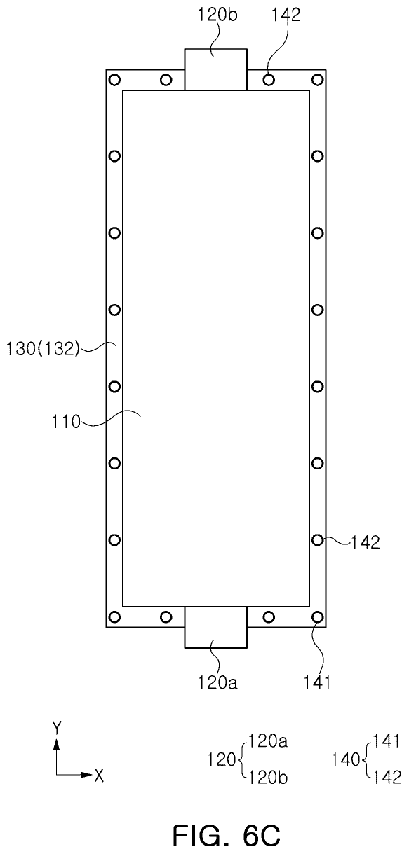

FIGS. 6A to 6C are plan views illustrating various modified examples of a state in which a cell casing 160 and a first support member 131 of a battery cell 100 according to a first embodiment are excluded.

Referring to FIGS. 6A to 6C, the elastic member 140 may be disposed symmetrically with respect to a central axis of the electrode assembly 110 in the Z-axis direction such that the support member 130 may provide a uniform surface pressure to the electrode assembly 110. The length of the elastic member 140 in a non-extended state may be equal to or less than the thickness h of the electrode assembly 110 in a non-expanded state.

As illustrated in FIGS. 6A to 6C, the elastic member 140 may include a first elastic member 141 disposed at the corner of the support member 130.

The first elastic member 141 may be located more inwardly, as compared to an edge of the first support member 131 and an edge of the second support member 132, but may be located in a corner portion of the electrode assembly 110.

The first elastic member 141 may be located in the corner portion to uniformly apply a force to the first support member 131 and the second support member 132. Such arrangement may be effective in suppressing expansion of the electrode assembly 110.

The elastic member 140 may further include a second elastic member 142 disposed in a region excluding the corner portion, in an edge of the support member 130.

The number of appropriate elastic members 140 required to provide a uniform surface pressure, and a position at which the elastic member 140 is disposed may be changed, depending on properties of the electrode assembly 110. The number of appropriate elastic members 140 required to provide a uniform surface pressure, and a position at which the elastic member 140 is disposed may be changed, depending on a material of the elastic member 140.

The second elastic member 142 may be located between the periphery of the first support member 131 and the periphery of the second support member 132 and the outside of the electrode assembly 110.

As illustrated in FIG. 6B, at least one second elastic member 142 may be disposed to be adjacent to the edge of the support member 130 in the first direction (Y-axis).

As illustrated in FIG. 6C, at least one second elastic member 142 may be disposed to be adjacent to edges of the support member 130 in the first direction (Y-axis) and edges of the support member 130 in the second direction (X-axis).

When the second elastic member 142 and the electrode lead 120 are located on the same surface, the second elastic member 142 may be disposed in a position in which the second elastic member 142 is not in contact with the electrode lead 120.

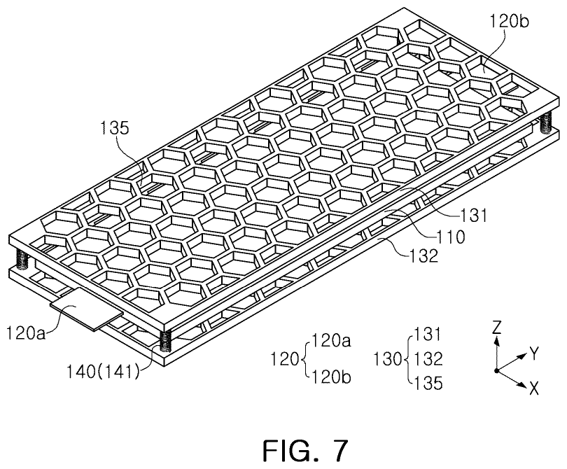

FIG. 7 is a perspective view illustrating an internal portion of a cell casing 160 of a battery cell 100 according to a second embodiment.

Referring to FIG. 7, a battery cell 100 according to a second embodiment of the present disclosure may be different from the first embodiment illustrated in FIGS. 1 to 4, and 5A to 6C in that a through-hole 135 is formed in a support member 130.

The battery cell 100 according to the second embodiment may include an electrode assembly 110, an electrode lead 120, a support member 130, an elastic member 140, and a cell casing 160. The descriptions of the first embodiment with respect to the electrode assembly 110, the electrode lead 120, the support member 130, the elastic member 140, and the cell casing 160 may be applied to the second embodiment.

At least one of a first support member 131 or a second support member 132 may include a plurality of through-holes 135.

The first support member 131 or the second support member 132 may include the plurality of through-holes 135 penetrating in a thickness direction (Z-axis) of the support member 130.

When the plurality of through-holes 135 are formed, the electrode assembly 110 may easily be in contact with an electrolyte. The plurality of through-holes 135 may discharge heat generated by the electrode assembly 110 externally.

The plurality of through-holes 135 may form a regular shape. When the plurality of through-holes 135 form the regular shape, heat may be uniformly dissipated, and may thus be more effective in preventing overheating of the electrode assembly 110. When the plurality of through-holes 135 form the regular shape, structural stability of the support member 130 may be improved. When the plurality of through-holes 135 form the regular shape, a uniform surface pressure may be provided to the electrode assembly 110.

For example, the plurality of through-holes 135 may have a lattice shape or a honeycomb shape. However, the present disclosure is not limited thereto.

The plurality of through-holes 135 formed in the first support member 131 and the plurality of through-holes 135 formed in the second support member 132 may have the same shape, but are not limited thereto.

In FIG. 7, the through-holes 135 are illustrated as holes with slightly exaggerated sizes for clarity of the illustration, and shapes and sizes of the through-holes 135 may be variously changed.

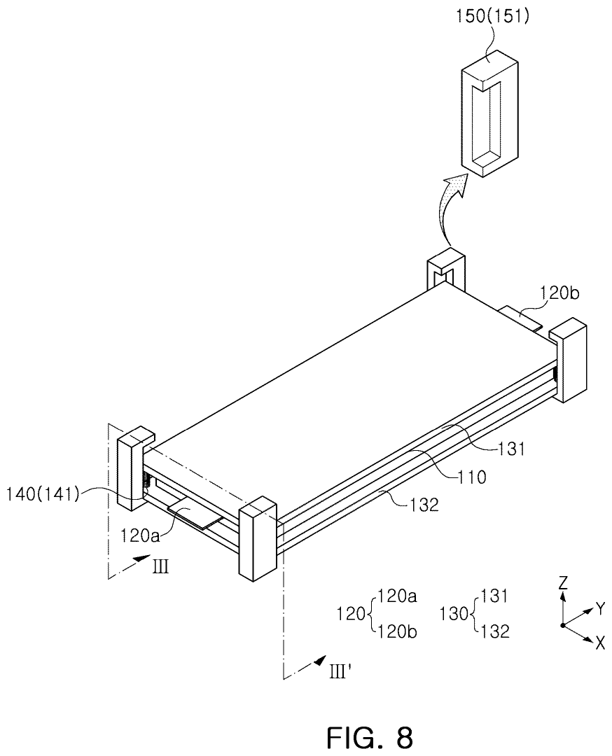

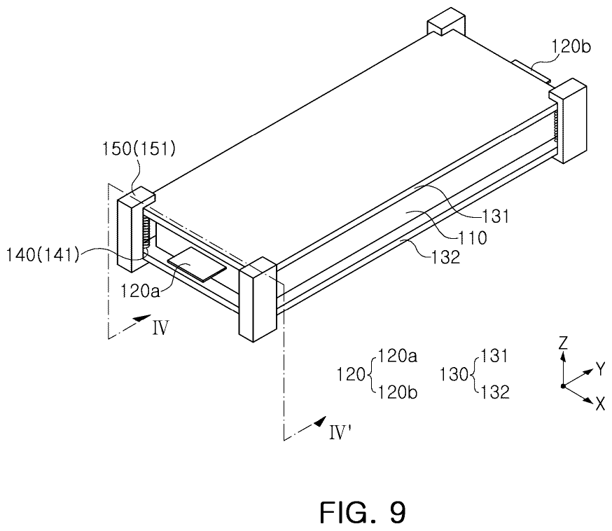

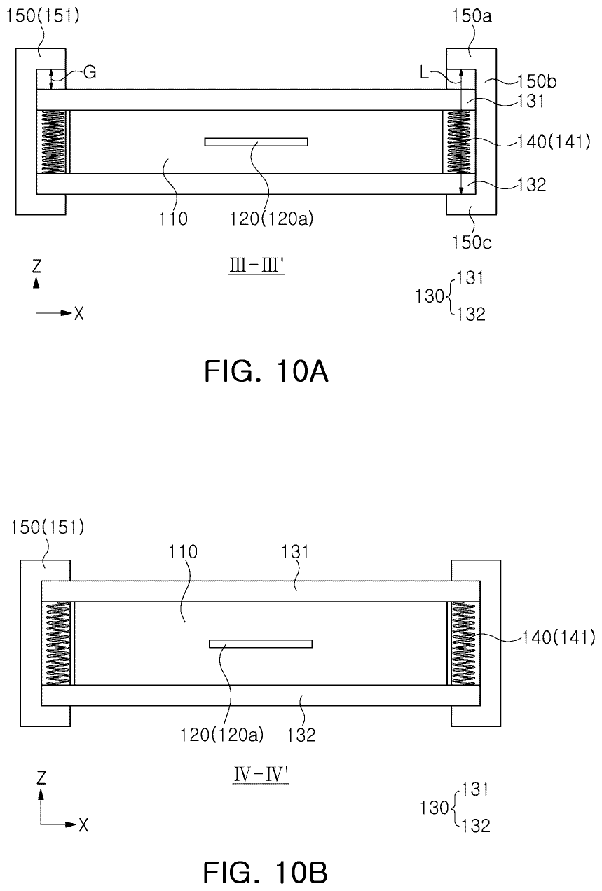

FIG. 8 is a perspective view illustrating an internal portion of a cell casing 160 of a battery cell 100 according to a third embodiment, and FIG. 9 is a perspective view illustrating a deformed state in the internal portion of the cell casing 160 illustrated in FIG. 8. FIG. 10A is a cross-sectional view of FIG. 8, taken along line III-III′, and FIG. 10B is a cross-sectional view of FIG. 9, taken along line IV-IV′.

Referring to FIGS. 8, 9, 10A, and 10B, a battery cell 100 according to a third embodiment of the present disclosure may be different from the first embodiment illustrated in FIGS. 1 to 4, and 5A to 6C in that a holder member 150 may be further included.

The battery cell 100 according to the third embodiment may include an electrode assembly 110, an electrode lead 120, a support member 130, an elastic member 140, and a cell casing 160. The descriptions of the first embodiment of the electrode assembly 110, the electrode lead 120, the support member 130, the elastic member 140, and the cell casing 160 may be applied to the third embodiment.

Referring to FIGS. 8, 9, 10A, and 10B, the battery cell 100 according to the third embodiment of the present disclosure may further include a holder member 150 coupled on an external side of a first support member 131 and an external side of a second support member 132 to suppress deformation of the elastic member 140.

The holder member 150 may restrict expansion of the electrode assembly 110. The holder member 150 may restrict movement of the support member 130 when the electrode assembly 110 expands. When the support member 130 is in contact with the holder member 150, the holder member 150 may apply a force to the support member 130 in a thickness direction (Z-axis) of the electrode assembly 110 to provide a surface pressure to the electrode assembly 110. To provide a uniform surface pressure, the holder member 150 may be disposed symmetrically with respect to a central axis of the electrode assembly 110 in the Z-axis direction.

An inner height L of the holder member may have a value smaller than a maximum deformation length of the elastic member 140. The maximum deformation length of the elastic member 140 means a length permanently deformed when the elastic member 140 is extended up to a length corresponding thereto, and not restored to an original state thereof. The maximum deformation length of the elastic member 140 may be appropriately selected according to a degree of expansion of the electrode assembly 110.

For example, the inner height L of the holder member may be 110% to 140% of a thickness h of the electrode assembly before the electrode assembly expands. The thickness h of the electrode assembly may be defined as a thickness before the electrode assembly expands. The inner height L of the holder member may be 110% or more, 120% or more, or 130% or more of the thickness h of the electrode assembly. The inner height L of the holder member may be 140% or less, 130% or less, or 120% or less of the thickness h of the electrode assembly. The inner height L of the holder member may be 120% to 140%, or 120% to 130% of the thickness h of the electrode assembly.

When the inner height L of the holder member is less than 110% of the thickness h of the electrode assembly, an excessive pressure may be applied to the support member 130 and the electrode assembly 110, thereby causing damage to an internal structure of the electrode assembly 110.

On the contrary, when the inner height L of the holder member exceeds 140% of the thickness h of the electrode assembly, deformation of the elastic member 140 is not limited, and thus the elastic member 140 may be permanently damaged. The expansion of the electrode assembly 110 may not be effectively suppressed.

The holder member 150 may suppress permanent deformation of the elastic member 140, thereby extending a lifespan of the battery cell 100.

The holder member 150 may be coupled to any one of the first support member 131 or the second support member 132. Therefore, any one of the first support member 131 or the second support member 132 may move between holder members 150.

For example, referring to FIGS. 10A and 10B, a lower portion 150c of the holder member may be coupled to the second support member 132, and the holder member 150 and the first support member 131 may not be coupled to each other. In a state in which the electrode assembly 110 does not expand, a gap G may be formed between an upper portion 150a of the holder member and the first support member 131. When the electrode assembly 110 expands and contracts, the first support member 131 may move in the gap G. In a state in which the electrode assembly 110 does not expand, the holder member 150 may not apply a force to the support member 130. In a state in which the electrode assembly 110 expands, the first support member 131 may be in contact with the upper portion 150a of the holder member. In a state in which the electrode assembly 110 expands, the upper portion 150a of the holder member may apply a force to the first support member 131. The support member 130 may provide a surface pressure to the electrode assembly 110.

Conversely, the upper portion 150a of the holder member may be coupled to the first support member 131, and the lower portion 150c of the holder member and the second support member 132 may not be coupled to each other. In this case, a gap G may be formed between the lower portion 150c of the holder member and the second support member 132 in a state in which the electrode assembly 110 does not expand. When the electrode assembly 110 expands and contracts, the second support member 132 may move in the gaps G. In a state in which the electrode assembly 110 does not expand, the holder member 150 may not apply a force to the support member 130. In a state in which the electrode assembly 110 expands, the second support member 132 may be in contact with the lower portion 150c of the holder member. In a state in which the electrode assembly 110 expands, the lower portion 150c of the holder member may apply a force to the second support member 132. The support member 130 may provide a surface pressure to the electrode assembly 110.

The holder member 150 may be coupled on an external side of the first support member 131 and an external side of the second support member 132, and may include a first holder member 151 disposed on a corner portion of the support member 130.

Referring to FIG. 8, the first holder member 151 may be formed to cover a corner portion of the electrode assembly 110. The first holder member 151 may include four surfaces. The first holder member 151 may be formed to simultaneously cover corners of the support member 130.

The first holder member 151 may be disposed in a position covering a first elastic member 141 to effectively suppress permanent deformation of the first elastic member 141.

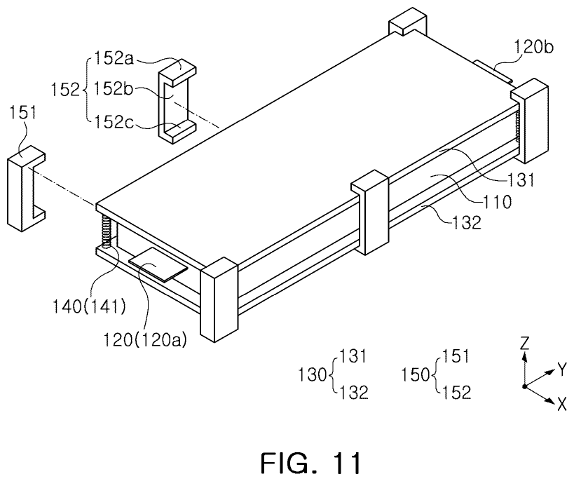

FIG. 11 is a perspective view illustrating an internal portion of a cell casing 160 of a battery cell 100 according to a fourth embodiment.

Referring to FIG. 11, a fourth embodiment may be different from the third embodiment in that a second holder member 152 is further included.

A battery cell 100 according to the fourth embodiment may include an electrode assembly 110, an electrode lead 120, a support member 130, an elastic member 140, a cell casing 160, and a holder member 150. The descriptions of the first embodiment with respect to the electrode assembly 110, the electrode lead 120, the support member 130, the elastic member 140, and the cell casing 160 may also be applied to the fourth embodiment. The description of the third embodiment with respect to the first holder member 151 may also be applied to the fourth embodiment.

The holder member 150 may include a first holder member 151 and a second holder member 152. The descriptions of the third embodiment of the holder member 150 and the first holder member 151 may be applied to the fourth embodiment.

The second holder member 152 may be coupled on an external side of a first support member 131 and an external side of a second support member 132, and may be disposed on a side surface of the support member 130.

Referring to FIG. 11, the second holder member 152 may be doubly bent to have a shape (C-like shape) covering a portion of a side surface of the first support member 131 and a portion of a side surface of the second support member 132.

For example, a lower portion 152c of the second holder member may be coupled to the second support member 132. The second holder member 152 may form a column portion 152b of the second holder member by first bending, and may form an upper portion 152a of the second holder member by second bending.

An inner height of the second holder member 152 may be the same as an inner height L of the first holder member 151.

The second holder member 152 may be disposed in a position covering a second elastic member 142. The second holder member 152 may effectively suppress permanent deformation of the second elastic member 142. The second holder member 152 may be disposed in a position not contacting the electrode lead 120.

The first holder member 151 or the second holder member 152 may include the same material as a material included in the support member 130, but is not limited thereto.

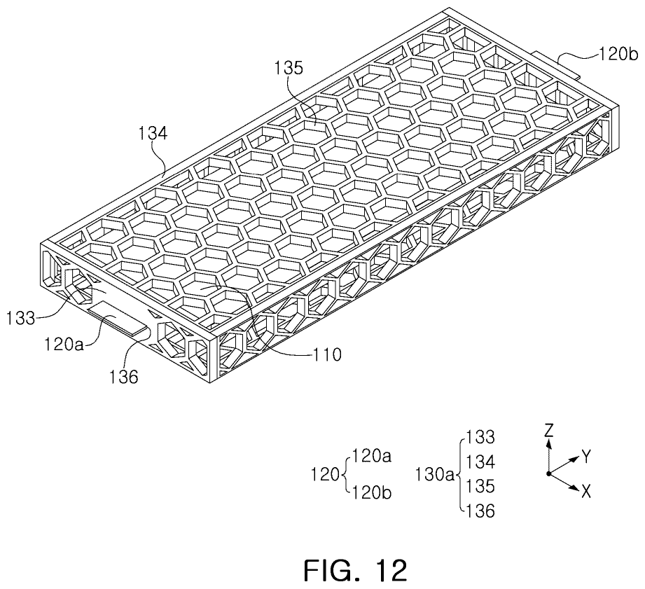

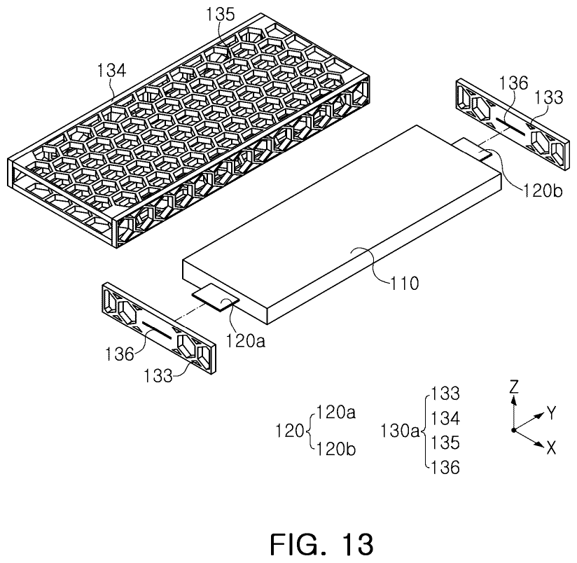

FIG. 12 is a perspective view illustrating an internal portion of a cell casing 160 of a battery cell 100 according to a fifth embodiment. FIG. 13 is an exploded perspective view of a battery cell 100 according to a fifth embodiment, from which a cell casing 160 is excluded.

A battery cell 100 according to a fifth embodiment may include an electrode assembly 110, an electrode lead 120, a support member 130, and a cell casing 160. The descriptions of the first embodiment with respect to the electrode assembly 110, the electrode lead 120, and the cell casing 160 may be applied to the fifth embodiment.

Referring to FIGS. 12 and 13, a battery cell 100 according to a fifth embodiment may include a support member 130a covering an entire surface of an electrode assembly 110.

The support member 130a may have the same shape as the electrode assembly 110. For example, when the electrode assembly 110 has a hexahedral shape, the support member 130a may also have a hexahedral shape. The support member 130a may have a shape covering six surfaces of the electrode assembly 110.

The descriptions of the first embodiment of material and physical properties (strength, rigidity, thermal resistance, insulation, or the like) of the support member 130 may be applied to the support member 130a of the fifth embodiment.

The support member 130a may include a third support member 133 covering a surface on which an electrode lead 120 is located, and a fourth support member 134 covering a surface on which the electrode lead 120 is not located. The third support member 133 may include an opening 136 formed to allow the electrode lead 120 to protrude outwardly.

The support member 130a may cover the entire surface of the electrode assembly 110 to effectively protect the electrode assembly 110 from external impact.

The support member 130a may cover the entire surface of the electrode assembly 110 to provide a uniform surface pressure with respect to expansion of the electrode assembly 110.

The fourth support member 134 may have an angular tube shape with open front and rear surfaces.

The electrode assembly 110 may be inserted into the fourth support member 134 through an open portion of the fourth support member 134. The third support member 133 may cover a surface of the electrode assembly 110 on which the electrode lead 120 is located. Thereafter, the third support member 133 may be coupled to the fourth support member 134 to fix the electrode assembly 110.

Coupling of the third support member 133 and the fourth support member 134 may be performed by welding or an adhesive. In addition, various techniques such as magnet coupling, forcedly fitting coupling, or the like may be applied, and the present disclosure is not limited to the coupling manners.

The third support member 133 may include the opening 136 having a shape corresponding to a shape of the electrode lead 120.

The opening 136 may serve to outwardly protrude the electrode lead 120.

At least one of the third support member 133 or the fourth support member 134 may include a plurality of through-holes 135.

The third support member 133 or the fourth support member 134 may include the plurality of through-holes 135 penetrating in a thickness direction of the support member 130a.

When the plurality of through-holes 135 are formed, the electrode assembly 110 may easily be in contact with an electrolyte. The plurality of through-holes 135 may discharge heat generated by the electrode assembly 110 externally.

The plurality of through-holes 135 may form a regular shape. When the plurality of through-holes 135 form the regular shape, heat may be uniformly dissipated, and may thus be more effective in preventing overheating of the electrode assembly 110. When the plurality of through-holes 135 form the regular shape, structural stability of the support member 130 may be improved. When the plurality of through-holes 135 form the regular shape, a uniform surface pressure may be provided to the electrode assembly 110.

For example, the plurality of through-holes 135 may have a lattice shape or a honeycomb shape. However, the present disclosure is not limited thereto.

The plurality of through-holes 135 formed in the third support member 133 and the plurality of through-holes 135 formed in the fourth support member 134 may have the same shape, but are not limited thereto.

The support member 130a may cover an entire surface of the electrode assembly 110 to more effectively protect the electrode assembly 110 against external impact. The support member 130a may suppress expansion of the electrode assembly 110 due to a swelling phenomenon. When the electrode assembly 110 expands due to the swelling phenomenon, the support member 130a may provide a surface pressure to the electrode assembly 110.

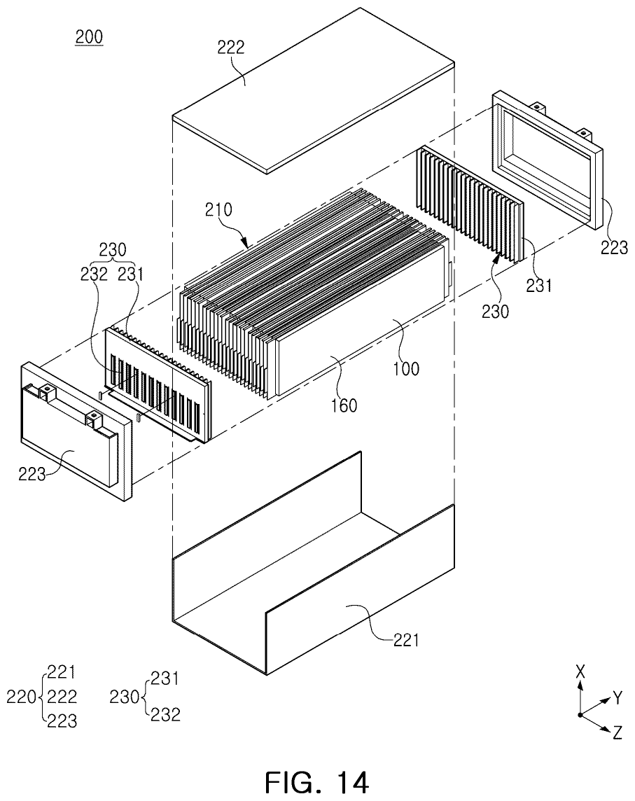

FIG. 14 is an exploded perspective view of a battery module 200.

Referring to FIG. 14, a battery module 200 according to the present disclosure may include a plurality of battery cells 100 and a module housing 220 including the plurality of battery cells 100. The battery module 200 according to the present disclosure may be applied with the battery cell 100 described with reference to FIGS. 1 to 4, 5A to 6C, 7 to 9, 10A, 10B, and 11 to 13.

Each of the plurality of battery cells 100 may include an electrode assembly 110, an electrode lead 120, a support member 130, an elastic member 140, and a cell casing 160. The support member 130 may include a first support member 131 and a second support member 132, as in the embodiments illustrated in FIGS. 1 to 4, 5A to 6C, and 7. Any one of the first support member 131 or the second support member 132 may include a through-hole 135.

Descriptions of the first or second embodiment of the electrode assembly 110, the electrode lead 120, the elastic member 140, the cell casing 160, the support member 130, and the through-hole 135 may be applied to each of the plurality of battery cells 100 included in the battery module 200 according to the present disclosure.

Each of the plurality of battery cells 100 may further include a holder member 150, as in the embodiment illustrated in FIGS. 8, 9, 10A, 10B, and 11. The holder member 150 may include a first holder member 151 and a second holder member 152.

The descriptions of the third or fourth embodiment of the holder member 150 may be applied to each of the plurality of battery cells 100 included in the battery module 200 according to the present disclosure.

A support member 130a may include a third support member 133 and a fourth support member 134, as in the embodiments illustrated in FIGS. 12 and 13. Any one of the third support member 133 or the fourth support member 134 may include a through-hole 135.

The description of the fifth embodiment of the support member 130a and the through-hole 135 may be applied to each of the plurality of battery cells 100 included in the battery module 200 according to the present disclosure.

The module housing 220 may have a shape covering at least a portion of a cell assembly 210. The module housing 220 may form at least a portion of an exterior of the battery module 200.

The module housing 220 may have various shapes or division structures. As an example, the module housing 220 may include a housing body 221 having a cross-sectional shape of which one side is open, and a housing cover 222 integrated with the housing body 221 to form an internal space. The housing cover 222 may cover an upper surface (top surface) of the cell assembly 210.

The cell assembly 210 may be disposed on an inner side of the module housing 220. At least one surface forming the module housing 220 may function as a heat dissipation plate dissipating heat generated by the battery cell 100 externally. At least a portion of the module housing 220 may be formed of a material having high thermal conductivity, such as metal. For example, the module housing 220 may include an aluminum material. However, the material of the module housing 220 is not limited thereto, and various materials may be used if the material is not metal but has strength and thermal conductivity similar to metal.

The bus bar assembly 230 may include a bus bar 231 having electrical conductivity, and a support plate 232 having electrical insulation electrically connected to the electrode lead 120 of the battery cell 100. The support plate 232 may be disposed between the plurality of battery cells 100 and the bus bar 231 having electrical conductivity, to support the bus bar 231. The support plate 232 may electrically insulate between the bus bar 231 and the cell casing 160 of the battery cell 100. As an example, the bus bar 231 may be fixed to the support plate 232 in a hooked or fused state. A method of coupling the bus bar 231 to the support plate 232 may be variously changed.

The busbar assembly 230 may be disposed in a position facing the electrode lead 120 of the battery cell 100 to be electrically connected to the plurality of electrode leads 120. For example, when the electrode lead 120 is disposed on both ends of the battery cell 100 in the first direction Y, the busbar assembly 230 may be disposed on both ends of the battery cell 100 in the first direction Y to be coupled to the electrode lead 120.

According to an embodiment of the present disclosure, a swelling phenomenon of a battery cell may be suppressed.

According to an embodiment of the present disclosure, an electrode assembly in a battery cell may be protected from external physical impact.

According to an embodiment of the present disclosure, rigidity and durability of a battery cell may be increased.

According to an embodiment of the present disclosure, expansion of an electrode assembly may be suppressed by providing a uniform surface pressure to the electrode assembly in a battery cell.

Only specific examples of implementations of certain embodiments may be described. Variations, improvements and enhancements of the disclosed embodiments and other embodiments may be made based on the disclosure of this patent document.

What is claimed is:

1. A battery cell comprising:
an electrode assembly including a positive electrode plate, a negative electrode plate, and a separator;
an electrode lead electrically connected to the electrode assembly;
a support member covering at least a portion of the electrode assembly;
an elastic member providing elastic force to the support member; and
a cell casing accommodating the electrode assembly, the support member, and the elastic member therein,
wherein the support member includes a first support member covering one surface of the electrode assembly, and a second support member covering the other surface of the electrode assembly, and
the elastic member provides elastic force to the first support member and the second support member.

2. The battery cell of claim 1, wherein the first support member covers a top surface of the electrode assembly,
the second support member covers a bottom surface of the electrode assembly, and
an area of the top surface and an area of the bottom surface of the electrode assembly are greater than an area of one of other surfaces of the electrode assembly, respectively.

3. The battery cell of claim 1, wherein at least one of the first support member or the second support member includes a plurality of through-holes.

4. The battery cell of claim 3, wherein the plurality of through-holes have a lattice shape or a honeycomb shape.

5. The battery cell of claim 1, wherein the elastic member is coupled to at least one of the first support member or the second support member.

6. The battery cell of claim 1, wherein the elastic member includes a first elastic member disposed on a corner portion of the support member.

7. The battery cell of claim 6, wherein the elastic member further includes a second elastic member disposed in a region excluding the corner portion, in edges of the support member.

8. The battery cell of claim 1, further including a holder member coupled on an external side of the first support member and an external side of the second support member to suppress deformation of the elastic member.

9. The battery cell of claim 8, wherein an inner height of the holder member is 110% to 140% of a thickness of the electrode assembly before expansion of the electrode assembly.

10. The battery cell of claim 8, wherein the holder member is coupled on the external side of the first support member and the external side of the second support member, and includes a first holder member disposed on a corner portion of the support member.

11. The battery cell of claim 10, wherein the holder member is coupled on the external side of the first support member and the external side of the second support member, and further includes a second holder member disposed on a side surface of the support member.

12. The battery cell of claim 1, wherein the support member includes a material having a heat resistance of 100° C. or higher and an insulation of 10⁶ Ωm (ohm meter) or higher.

13. The battery cell of claim 1, wherein the support member includes a material in which a ceramic-based filler is included in a polymer matrix.

14. A battery cell comprising:
an electrode assembly including a positive electrode plate, a negative electrode plate, and a separator;
an electrode lead electrically connected to the electrode assembly;
a support member covering an entire surface of the electrode assembly; and
a cell casing accommodating the electrode assembly and the support member therein,
wherein the support member includes a third support member covering a surface on which the electrode lead is located, and a fourth support member covering a surface on which the electrode lead is not located, and
the third support member includes an opening formed to protrude the electrode lead externally.

15. The battery cell of claim 14, wherein at least one of the third support member or the fourth support member includes a plurality of through-holes.

16. A battery module comprising:
a plurality of battery cells; and
a module housing including the plurality of battery cells,
wherein the support member includes:
an electrode assembly including a positive electrode plate, a negative electrode plate, and a separator;
an electrode lead electrically connected to the electrode assembly;
a support member covering at least a portion of the electrode assembly;
an elastic member providing elastic force to the support member; and
a cell casing accommodating the electrode assembly, the support member, and the elastic member therein,
wherein the support member includes a first support member covering one surface of the electrode assembly, and a second support member covering the other surface of the electrode assembly, and
the elastic member provides elastic force to the first support member and the second support member.
